(19) United States
(12) Patent Application Publication
(10) Pub. No.: US 2020/0310421 A1
(43) Pub. Date: Oct. 1, 2020

(54) ONLINE DRIVING PERFORMANCE EVALUATION USING SPATIAL AND TEMPORAL TRAFFIC INFORMATION FOR AUTONOMOUS DRIVING SYSTEMS

(71) Applicant: GM GLOBAL TECHNOLOGY OPERATIONS LLC, Detroit, MI (US)

(72) Inventors: Hyukseong Kwon, Thousand Oaks, CA (US); Aashish N. Patel, Los Angeles, CA (US); Michael J. Daily, Thousand Oaks, CA (US)

(21) Appl. No.: 16/365,490

(22) Filed: Mar. 26, 2019

(51) Int. Cl. G05D 1/00; G05D 1/02

(52) U.S. Cl. CPC G05D 1/0088; G05D 1/0221

(57) ABSTRACT

An autonomous vehicle, system and method of operating the autonomous vehicle. The system includes a performance evaluator, a decision module and a navigation system. The performance evaluator determines a performance grade for each of a plurality of decisions for operating the autonomous vehicle. The decision module selects a decision have a greatest performance grade. The navigation system operates the autonomous vehicle using the selected decision.

The subject disclosure relates to autonomous vehicles and, in particular, to a system and method of evaluating a driving performance of a selected driving decision in order to improve decision selection.

Autonomous vehicles are intended to move a passenger from one place to another with no or minimal input from the passenger. Such vehicles require the ability to obtain knowledge about agents in its environment, predict their possible future trajectories and to calculate and implement a driving decision for the autonomous vehicle based on this knowledge. While various driving decisions can be proposed for the autonomous vehicle for a selected scenario, it is useful to be able to consistently select the driving decision that is most suitable to the scenario. Accordingly, it is desirable to provide a system which can evaluate a driving decision in order to implement an optimal driving decision at the autonomous vehicle.

### SUMMARY

In one exemplary embodiment, a method of operating the autonomous vehicle is disclosed. A plurality of decisions for operating the autonomous vehicle are received at a decision resolver of a cognitive processor associated with the autonomous vehicle. A performance grade is determined for each of the plurality of decisions. A decision have a greatest performance grade is selected. The autonomous vehicle is operated using the selected decision.

In addition to one or more of the features described herein, the performance grade is a combination of an instantaneous performance grade and a temporal performance grade. The instantaneous performance grade is based on a compliance with a traffic rule and a compliance with a flow of traffic. The temporal performance grade is determined over a time period extending from a start time in the past to an end time in the future. The start time is the most recent of (i) a start time of a new event; and (ii) a time indicated by a selected time interval prior to a current time. The method further includes using a standard deviation of grades in the temporal performance grade to weight the contribution of each of the instantaneous performance grade and the temporal performance grade in the performance grade. The temporal performance grade is a combination of a mean grade over a time interval and a minimum grade over the time interval.

In another exemplary embodiment, a system for operating an autonomous vehicle is disclosed. The system includes a performance evaluator, a decision module and a navigation system. The performance evaluator determines a performance grade for each of a plurality of decisions for operating the autonomous vehicle. The decision module selects a decision have a greatest performance grade. The navigation system operates the autonomous vehicle using the selected decision.

In addition to one or more of the features described herein, the performance evaluator determines the performance grade as a combination of an instantaneous performance grade and a temporal performance grade. The system further includes a compliance module that determines a compliance of the vehicle with a traffic rule and a compliance with a flow of traffic, wherein the instantaneous performance grade is based on a compliance with a traffic rule and a compliance with a flow of traffic. The performance evaluator determines the temporal performance grade over a time period extending from a start time in the past to an end time in the future. The start time is the most recent of (i) a start time of a new event; and (ii) a time indicated by a selected time interval prior to a current time. The performance evaluator uses a standard deviation of grades in the temporal performance grade to weight the contribution of each of the instantaneous performance grade and the temporal performance grade in the performance grade. The temporal performance grade is a combination of a mean grade over a time interval and a minimum grade over the time interval.

In yet another exemplary embodiment, an autonomous vehicle is disclosed. The autonomous vehicle includes a performance evaluator, a decision module and a navigation system. The performance evaluator determines a performance grade for each of a plurality of decisions for operating the autonomous vehicle. The decision module selects a decision have a greatest performance grade. The navigation system operates the autonomous vehicle using the selected decision.

In addition to one or more of the features described herein, the performance evaluator determines the performance grade as a combination of an instantaneous performance grade and a temporal performance grade. The autonomous vehicle further includes a compliance module that determines a compliance of the vehicle with a traffic rule and a compliance with a flow of traffic, wherein the instantaneous performance grade is based on a compliance with a traffic rule and a compliance with a flow of traffic. The performance evaluator determines the temporal performance grade over a time period extending from a start time in the past to an end time in the future. The performance evaluator uses a standard deviation of grades in the temporal performance grade to weight the contribution of each of the instantaneous performance grade and the temporal performance grade in the performance grade. The temporal performance grade is a combination of a mean grade over a time interval and a minimum grade over the time interval.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an autonomous vehicle with an associated trajectory planning system depicted in accordance with various embodiments;

FIG. 2 shows an illustrative control system including a cognitive processor integrated with an autonomous vehicle or vehicle simulator;

FIG. 3 shows a system of the prevent disclosure for operating the vehicle using decisions selected based on a performance grade of the decision;

FIG. 4 diagrammatically illustrates a process for determining a performance grade for a plurality of solutions in order to operate an autonomous vehicle;

FIG. 5 shows the diagrammed process of FIG. 4 emphasizing a sub-process for determining a temporal performance grade for the plurality of solutions; and

FIG. 6 shows the diagrammed process of FIG. 4 emphasizing a sub-process for determining a final performance grade for the plurality of solutions and selecting an optimal decision.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

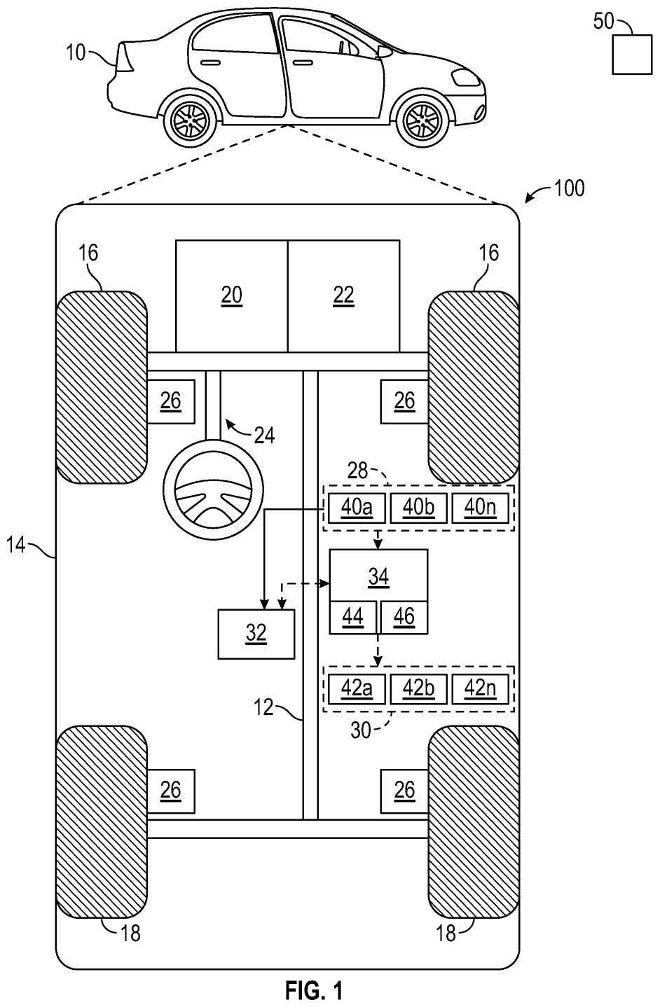

In accordance with an exemplary embodiment, FIG. 1 shows an autonomous vehicle 10 with an associated trajectory planning system depicted at 100 in accordance with various embodiments. In general, the trajectory planning system 100 determines a trajectory plan for automated driving of the autonomous vehicle 10. The autonomous vehicle 10 generally includes a chassis 12, a body 14, front wheels 16, and rear wheels 18. The body 14 is arranged on the chassis 12 and substantially encloses components of the autonomous vehicle 10. The body 14 and the chassis 12 may jointly form a frame. The wheels 16 and 18 are each rotationally coupled to the chassis 12 near respective corners of the body 14.

In various embodiments, the trajectory planning system 100 is incorporated into the autonomous vehicle 10. The autonomous vehicle 10 is, for example, a vehicle that is automatically controlled to carry passengers from one location to another. The autonomous vehicle 10 is depicted in the illustrated embodiment as a passenger car, but it should be appreciated that any other vehicle including motorcycles, trucks, sport utility vehicles (SUVs), recreational vehicles (RVs), etc., can also be used. At various levels, an autonomous vehicle can assist the driver through a number of methods, such as warning signals to indicate upcoming risky situations, indicators to augment situational awareness of the driver by predicting movement of other agents warning of potential collisions, etc. The autonomous vehicle has different levels of intervention or control of the vehicle through coupled assistive vehicle control all the way to full control of all vehicle functions. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, a cognitive processor 32, and at least one controller 34. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16 and 18. The brake system 26 may, in various embodiments, include friction brakes, brake by wire, a regenerative braking system such as an electric machine, and/or other appropriate braking systems. The steering system 24 influences a position of the vehicle wheels 16 and 18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. The sensing devices 40a-40n obtain measurements or data related to various objects or agents 50 within the vehicle's environment. Such agents 50 can be, but are not limited to, other vehicles, pedestrians, bicycles, motorcycles, etc., as well as non-moving objects. The sensing devices 40a-40n can also obtain traffic data, such as information regarding traffic signals and signs, etc.

The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but not limited to, doors, a trunk, and cabin features such as ventilation, music, lighting, etc. (not numbered).

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which includes an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms.

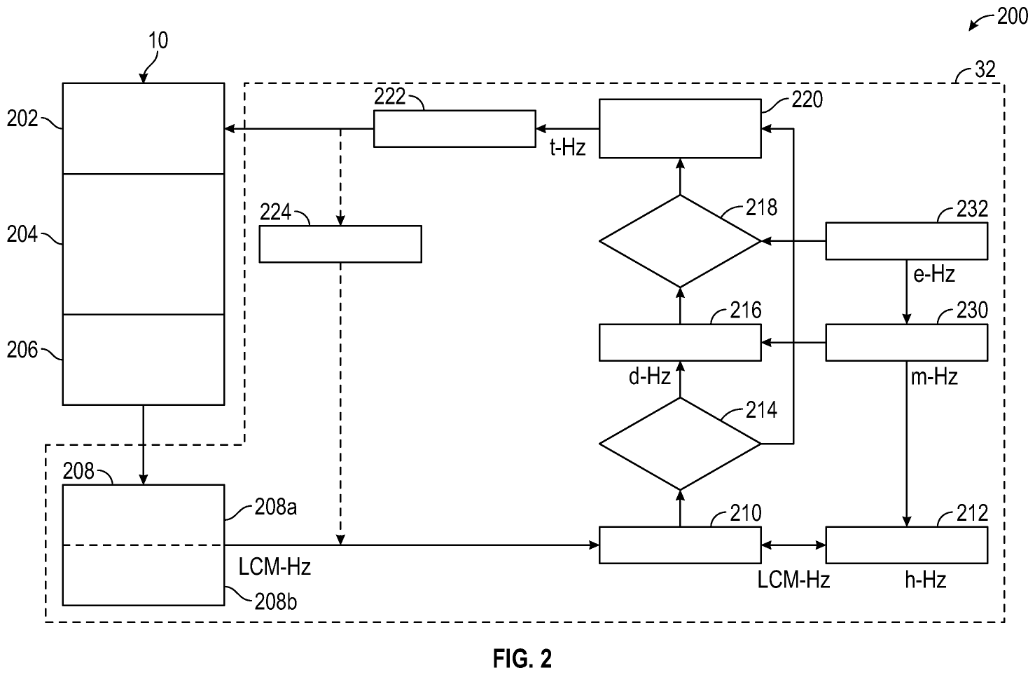

The controller 34 is further in communication with the cognitive processor 32. The cognitive processor 32 receives various data from the controller 34 and from the sensing devices 40a-40n of the sensor system 28 and performs various calculations in order to provide a trajectory to the controller 34 for the controller 34 to implement at the autonomous vehicle 10 via the one or more actuator devices 42a-42n. A detailed discussion of the cognitive processor 32 is provided with respect to FIG. 2.

FIG. 2 shows an illustrative control system 200 including a cognitive processor 32 integrated with an autonomous vehicle 10. In various embodiment the autonomous vehicle 10 can be a vehicle simulator that simulates various driving scenarios for the autonomous vehicle 10 and simulates various response of the autonomous vehicle 10 to the scenarios.

The autonomous vehicle 10 includes a data acquisition system 204 (e.g., sensors 40a-40n of FIG. 1). The data acquisition system 204 obtains various data for determining a state of the autonomous vehicle 10 and various agents in the environment of the autonomous vehicle 10. Such data includes, but is not limited to, kinematic data, position or pose data, etc., of the autonomous vehicle 10 as well as data about other agents, including as range, relative speed (Doppler), elevation, angular location, etc. The autonomous vehicle 10 further includes a sending module 206 that packages the acquired data and sends the packaged data to the communication interface 208 of the cognitive processor 32, as discussed below. The autonomous vehicle 10 further includes a receiving module 202 that receives operating commands from the cognitive processor 32 and performs the commands at the autonomous vehicle 10 to navigate the autonomous vehicle 10. The cognitive processor 32 receives the data from the autonomous vehicle 10, computes a trajectory for the autonomous vehicle 10 based on the provided state information and the methods disclosed herein and provides the trajectory to the autonomous vehicle 10 at the receiving module 202. The autonomous vehicle 10 then implements the trajectory provided by the cognitive processor 32.

The cognitive processor 32 includes various modules for communication with the autonomous vehicle 10, including an interface module 208 for receiving data from the autonomous vehicle 10 and a trajectory sender 222 for sending instructions, such as a trajectory to the autonomous vehicle 10. The cognitive processor 32 further includes a working memory 210 that stores various data received from the autonomous vehicle 10 as well as various intermediate calculations of the cognitive processor 32. A hypothesizer module(s) 212 of the cognitive processor 32 is used to propose various hypothetical trajectories and motions of one or more agents in the environment of the autonomous vehicle 10 using a plurality of possible prediction methods and state data stored in working memory 210. A hypothesis resolver 214 of the cognitive processor 32 receives the plurality of hypothetical trajectories for each agent in the environment and determines a most likely trajectory for each agent from the plurality of hypothetical trajectories.

The cognitive processor 32 further includes one or more decider modules 216 and a decision resolver 218. The decider module(s) 216 receives the most likely trajectory for each agent in the environment from the hypothesis resolver 214 and calculates a plurality of candidate trajectories and behaviors for the autonomous vehicle 10 based on the most likely agent trajectories. Each of the plurality of candidate trajectories and behaviors is provided to the decision resolver 218. The decision resolver 218 selects or determines an optimal or desired trajectory and behavior for the autonomous vehicle 10 from the candidate trajectories and behaviors.

The cognitive processor 32 further includes a trajectory planner 220 that determines an autonomous vehicle trajectory that is provided to the autonomous vehicle 10. The trajectory planner 220 receives the vehicle behavior and trajectory from the decision resolver 218, an optimal hypothesis for each agent 50 from the hypothesis resolver 214, and the most recent environmental information in the form of “state data” to adjust the trajectory plan. This additional step at the trajectory planner 220 ensures that any anomalous processing delays in the asynchronous computation of agent hypotheses is checked against the most recent sensed data from the data acquisition system 204. This additional step updates the optimal hypothesis accordingly in the final trajectory computation in the trajectory planner 220.

The determined vehicle trajectory is provided from the trajectory planner 220 to the trajectory sender 222 which provides a trajectory message to the autonomous vehicle 10 (e.g., at controller 34) for implementation at the autonomous vehicle 10.

The cognitive processor 32 further includes a modulator 230 that controls various limits and thresholds for the hypothesizer module(s) 212 and decider module(s) 216. The modulator 230 can also apply changes to parameters for the hypothesis resolver 214 to affect how it selects the optimal hypothesis object for a given agent 50, deciders, and the decision resolver. The modulator 230 is a discriminator that makes the architecture adaptive. The modulator 230 can change the calculations that are performed as well as the actual result of deterministic computations by changing parameters in the algorithms themselves.

An evaluator module 232 of the cognitive processor 32 computes and provides contextual information to the cognitive processor including error measures, hypothesis confidence measures, measures on the complexity of the environment and autonomous vehicle 10 state, performance evaluation of the autonomous vehicle 10 given environmental information including agent hypotheses and autonomous vehicle trajectory (either historical, or future). The modulator 230 receives information from the evaluator 232 to compute changes to processing parameters for hypothesizers 212, the hypothesis resolver 214, the deciders 216, and threshold decision resolution parameters to the decision resolver 218. A virtual controller 224 implements the trajectory message and determines a feedforward trajectory of various agents 50 in response to the trajectory.

Modulation occurs as a response to uncertainty as measured by the evaluator module 232. In one embodiment, the modulator 230 receives confidence levels associated with hypothesis objects. These confidence levels can be collected from hypothesis objects at a single point in time or over a selected time window. The time window may be variable. The evaluator module 232 determines the entropy of the distribution of these confidence levels. In addition, historical error measures on hypothesis objects can also be collected and evaluated in the evaluator module 232.

These types of evaluations serve as an internal context and measure of uncertainty for the cognitive processor 32. These contextual signals from the evaluator module 232 are utilized for the hypothesis resolver 214, decision resolver, 218, and modulator 230 which can change parameters for hypothesizer modules 212 based on the results of the calculations.

The various modules of the cognitive processor 32 operate independently of each other and are updated at individual update rates (indicated by, for example, LCM-Hz, h-Hz, d-Hz, e-Hz, m-Hz, t-Hz in FIG. 2).

In operation, the interface module 208 of the cognitive processor 32 receives the packaged data from the sending module 206 of the autonomous vehicle 10 at a data receiver 208a and parses the received data at a data parser 208b. The data parser 208b places the data into a data format, referred to herein as a property bag, that can be stored in working memory 210 and used by the various hypothesizer modules 212, decider modules 216, etc. of the cognitive processor 32. The particular class structure of these data formats should not be considered a limitation of the invention.

Working memory 210 extracts the information from the collection of property bags during a configurable time window to construct snapshots of the autonomous vehicle and various agents. These snapshots are published with a fixed frequency and pushed to subscribing modules. The data structure created by working memory 210 from the property bags is a “State” data structure which contains information organized according to timestamp. A sequence of generated snapshots therefore encompass dynamic state information for another vehicle or agent. Property bags within a selected State data structure contain information about objects, such as other agents, the autonomous vehicle, route information, etc. The property bag for an object contains detailed information about the object, such as the object's location, speed, heading angle, etc. This state data structure flows throughout the rest of the cognitive processor 32 for computations. State data can refer to autonomous vehicle states as well as agent states, etc.

The hypothesizer module(s) 212 pulls State data from the working memory 210 in order to compute possible outcomes of the agents in the local environment over a selected time frame or time step. Alternatively, the working memory 210 can push State data to the hypothesizer module(s) 212. The hypothesizer module(s) 212 can include a plurality of hypothesizer modules, with each of the plurality of hypothesizer modules employing a different method or technique for determining the possible outcome of the agent(s). One hypothesizer module may determine a possible outcome using a kinematic model that applies basic physics and mechanics to data in the working memory 210 in order to predict a subsequent state of each agent 50. Other hypothesizer modules may predict a subsequent state of each agent 50 by, for example, employing a kinematic regression tree to the data, applying a Gaussian Mixture Model/Markovian mixture model (GMM-HMM) to the data, applying a recursive neural network (RNN) to the data, other machine learning processes, performing logic based reasoning on the data, etc. The hypothesizer modules 212 are modular components of the cognitive processor 32 and can be added or removed from the cognitive processor 32 as desired.

Each hypothesizer module 212 includes a hypothesis class for predicting agent behavior. The hypothesis class includes specifications for hypothesis objects and a set of algorithms. Once called, a hypothesis object is created for an agent from the hypothesis class. The hypothesis object adheres to the specifications of the hypothesis class and uses the algorithms of the hypothesis class. A plurality of hypothesis objects can be run in parallel with each other. Each hypothesizer module 212 creates its own prediction for each agent 50 based on the working current data and sends the prediction back to the working memory 210 for storage and for future use. As new data is provided to the working memory 210, each hypothesizer module 212 updates its hypothesis and pushes the updated hypothesis back into the working memory 210. Each hypothesizer module 212 can choose to update its hypothesis at its own update rate (e.g., rate h-Hz). Each hypothesizer module 212 can individually act as a subscription service from which its updated hypothesis is pushed to relevant modules.

Each hypothesis object produced by a hypothesizer module 212 is a prediction in the form of a state data structure for a vector of time, for defined entities such as a location, speed, heading, etc. In one embodiment, the hypothesizer module(s) 212 can contain a collision detection module which can alter the feedforward flow of information related to predictions. Specifically, if a hypothesizer module 212 predicts a collision of two agents 50, another hypothesizer module may be invoked to produce adjustments to the hypothesis object in order to take into account the expected collision or to send a warning flag to other modules to attempt to mitigate the dangerous scenario or alter behavior to avoid the dangerous scenario.

For each agent 50, the hypothesis resolver 118 receives the relevant hypothesis objects and selects a single hypothesis object from the hypothesis objects. In one embodiment, the hypothesis resolver 118 invokes a simple selection process. Alternatively, the hypothesis resolver 118 can invoke a fusion process on the various hypothesis objects in order to generate a hybrid hypothesis object.

Since the architecture of the cognitive processor is asynchronous, if a computational method implemented as a hypothesis object takes longer to complete, then the hypothesis resolver 118 and downstream decider modules 216 receive the hypothesis object from that specific hypothesizer module at an earliest available time through a subscription-push process. Time stamps associated with a hypothesis object informs the downstream modules of the relevant time frame for the hypothesis object, allowing for synchronization with hypothesis objects and/or state data from other modules. The time span for which the prediction of the hypothesis object applies is thus aligned temporally across modules.

For example, when a decider module 216 receives a hypothesis object, the decider module 216 compares the time stamp of the hypothesis object with a time stamp for most recent data (i.e., speed, location, heading, etc.) of the autonomous vehicle 10. If the time stamp of the hypothesis object is considered too old (e.g., pre-dates the autonomous vehicle data by a selected time criterion) the hypothesis object can be disregarded until an updated hypothesis object is received. Updates based on most recent information are also performed by the trajectory planner 220.

The decider module(s) 216 includes modules that produces various candidate decisions in the form of trajectories and behaviors for the autonomous vehicle 10. The decider module(s) 216 receives a hypothesis for each agent 50 from the hypothesis resolver 214 and uses these hypotheses and a nominal goal trajectory for the autonomous vehicle 10 as constraints. The decider module(s) 216 can include a plurality of decider modules, with each of the plurality of decider modules using a different method or technique for determining a possible trajectory or behavior for the autonomous vehicle 10. Each decider module can operate asynchronously and receives various input states from working memory 212, such as the hypothesis produced by the hypothesis resolver 214. The decider module(s) 216 are modular components and can be added or removed from the cognitive processor 32 as desired. Each decider module 216 can update its decisions at its own update rate (e.g., rate d-Hz).

Similar to a hypothesizer module 212, a decider module 216 includes a decider class for predicting an autonomous vehicle trajectory and/or behavior. The decider class includes specifications for decider objects and a set of algorithms. Once called, a decider object is created for an agent 50 from the decider class. The decider object adheres to the specifications of the decider class and uses the algorithm of the decider class. A plurality of decider objects can be run in parallel with each other.

The decision resolver 218 receives the various decisions generated by the one or more decider modules and produces a single trajectory and behavior object for the autonomous vehicle 10. The decision resolver can also receive various contextual information from evaluator modules 232, wherein the contextual information is used in order to produce the trajectory and behavior object.

The trajectory planner 220 receives the trajectory and behavior objects from the decision resolver 218 along with the state of the autonomous vehicle 10. The trajectory planner 220 then generates a trajectory message that is provided to the trajectory sender 222. The trajectory sender 222 provides the trajectory message to the autonomous vehicle 10 for implementation at the autonomous vehicle 10, using a format suitable for communication with the autonomous vehicle 10.

The trajectory sender 222 also sends the trajectory message to virtual controller 224. The virtual controller 224 provides data in a feed-forward loop for the cognitive processor 32. The trajectory sent to the hypothesizer module(s) 212 in subsequent calculations are refined by the virtual controller 224 to simulate a set of future states of the autonomous vehicle 10 that result from attempting to follow the trajectory. These future states are used by the hypothesizer module(s) 212 to perform feed-forward predictions.

Various aspects of the cognitive processor 32 provide feedback loops. A first feedback loop is provided by the virtual controller 224. The virtual controller 224 simulates an operation of the autonomous vehicle 10 based on the provided trajectory and determines or predicts future states taken by each agent 50 in response to the trajectory taken by the autonomous vehicle 10. These future states of the agents can be provided to the hypothesizer modules as part of the first feedback loop.

A second feedback loop occurs because various modules will use historical information in their computations in order to learn and update parameters. Hypothesizer module(s) 212, for example, can implement their own buffers in order to store historical state data, whether the state data is from an observation or from a prediction (e.g., from the virtual controller 224). For example, in a hypothesizer module 212 that employs a kinematic regression tree, historical observation data for each agent is stored for several seconds and used in the computation for state predictions.

The hypothesis resolver 214 also has feedback in its design as it also utilizes historical information for computations. In this case, historical information about observations is used to compute prediction errors in time and to adapt hypothesis resolution parameters using the prediction errors. A sliding window can be used to select the historical information that is used for computing prediction errors and for learning hypothesis resolution parameters. For short term learning, the sliding window governs the update rate of the parameters of the hypothesis resolver 214. Over larger time scales, the prediction errors can be aggregated during a selected episode (such as a left turn episode) and used to update parameters after the episode.

The decision resolver 218 also uses historical information for feedback computations. Historical information about the performance of the autonomous vehicle trajectories is used to compute optimal decisions and to adapt decision resolution parameters accordingly. This learning can occur at the decision resolver 218 at multiple time scales. In a shortest time scale, information about performance is continuously computed using evaluator modules 232 and fed back to the decision resolver 218. For instance, an algorithm can be used to provide information on the performance of a trajectory provided by a decider module based on multiple metrics as well as other contextual information. This contextual information can be used as a reward signal in reinforcement learning processes for operating the decision resolver 218 over various time scales. Feedback can be asynchronous to the decision resolver 218, and the decision resolver 218 can adapt upon receiving the feedback.

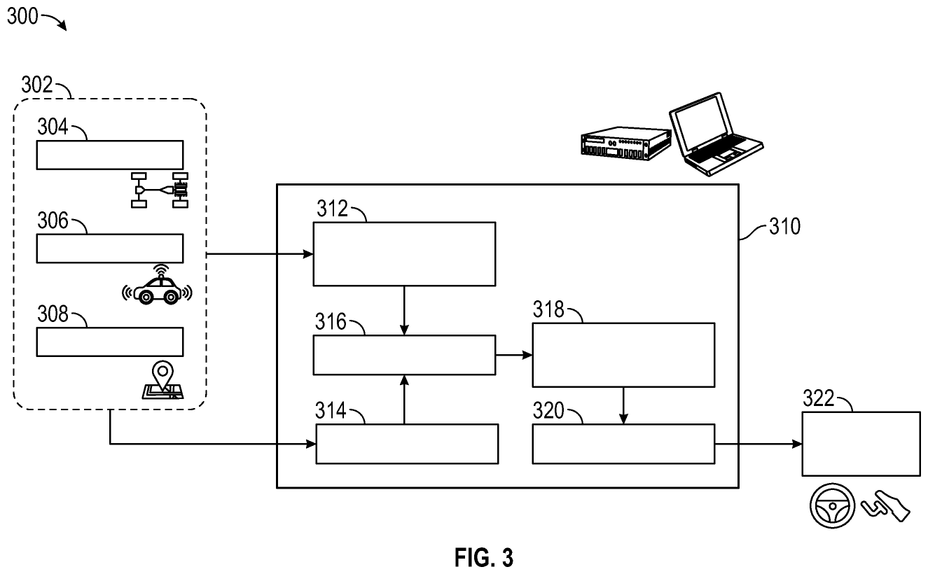

FIG. 3 shows a system 300 of the prevent disclosure for operating the vehicle using decisions selected based on a performance grade of the decision. The system 300 includes a sensor system 302 for obtaining and gathering various data about the operating environment of the autonomous vehicle 10 and a computational processor 310 that proposes and selects a driving decision to implement at the autonomous vehicle based on the operating environment thereof The sensor system 302 includes various sensors and detectors for determining a vehicle status 304 of the autonomous vehicle 10. Vehicle status 304 includes, but is not limited to a location, speed, orientation or heading of the autonomous vehicle. Additionally, the sensor system 302 includes sensors for detecting sensor data 306 regarding agent vehicles within the environment of the autonomous vehicle. Such sensor data 306 includes the location, speed and orientation of one or more agents 50 within in the scene, as well as other information such as lane change indicators, flashing lights, etc., within in the scene. Furthermore, the sensor system 302 includes a receiver for receiving various map data 308. Such map data 308 can provide information on traffic rules, such as speed limits, intersections, stop signs, road conditions and road type, etc. In various embodiments, map data 306 can be verified using information retrieved at the other sensors of the sensor system 302.

The computational processor 310 receives the data from the sensor system 302 and performs various operations in order to determine a performance grade for a solution of the autonomous vehicle 10. In particular, the computational processor 310 includes a traffic rule and flow module 312 that determines or confirms traffic rules as well as estimates a traffic flow pattern in the neighborhood or environment of the autonomous vehicle. A prediction module 314 of the computational processor 310 generates a plurality of solutions for the autonomous vehicle 10 based on the received sensor data, including agent locations, speeds, headings, etc. A compliance module 316 receives the traffic rules and traffic flow pattern from the traffic rule and flow module 312 and receives the plurality of solutions from the prediction module 314 and tests each solution to determine a grade for the solution with respect to its adherence to traffic rules and/or traffic flow patterns. The compliance module 316 calculates various compliance values which are sent to the performance evaluator 318. The performance evaluator 318 determines both an instantaneous (spatial) grade and a temporal grade for each solution based on the compliance factors. A decision module 320 then selects a solution to be implemented at the autonomous vehicle from the instantaneous grade, the temporal grade, or a combination thereof. The selected solution is then used at a vehicle controller 322 to operate the autonomous vehicle 10.

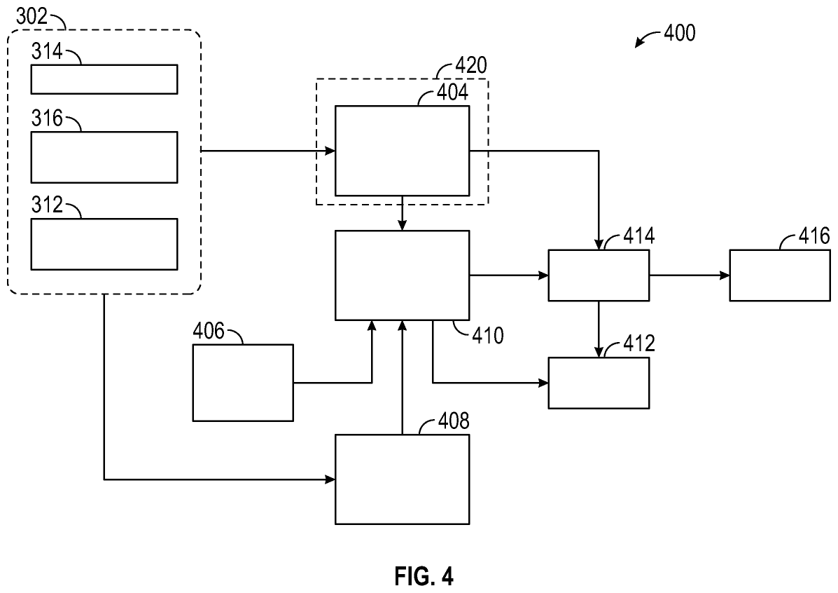

FIG. 4 diagrammatically illustrates a process 400 for determining a performance grade for a plurality of solutions in order to operate an autonomous vehicle 10. The box 302 representatively includes the process of determining traffic rules and traffic flow (box 312), generating a plurality of solutions (box 314) and determine compliance levels (box 316) for each of the plurality of solutions with respect to the traffic rules and traffic flow, as described in FIG. 3.

Box 404 shows a module for determining an instantaneous (also referred to herein as “spatial”) performance grade for a solution. The instantaneous grade G_{INST}(t) at a selected time frame t can be calculated as a product of traffic rule compliance and traffic flow compliance, using the equation of Eq. (1):

G_{INST}(t)=R(t)F(t) Eq. (1)

where R(t) is a value representing a traffic rule compliance factor or the degree to which the autonomous vehicle complies with traffic rules and regulations, and F(t) is a value representing a traffic flow compliance factor. R(t) and F(t) are generally determined at the compliance module 314. Traffic rule compliance indicates how well the driver (as well as the autonomous vehicle 10) follows traffic rules. Traffic flow compliance represents how well the driver or autonomous vehicle 10 stays safely and efficiently within the flow of traffic while maintaining appropriate speeds and headings.

The traffic rule compliance factor R(t) can be determined using various methods. An exemplary method is shown in Eq. (2):

R(t)=αR_{BASE}(t)+(1−α)R_{EXCEPT}(t) Eq. (2)

where R_{BASE}(t) is a base rule compliance factor at time t, R_{EXCEPT}(t) is a rule exception compliance factor and α is a weighting factor between the base rule compliance factor and the rule exception compliance factor. The base rule compliance factor is generally specific to a selected region or location. Within a specific region, when the driver complies with the rule correctly, the value is awarded of R_{BASE}(t)=1. When the driver completely ignores the rule, the value of R_{BASE}(t)=0. Thus, when a driver comes to a complete stop at a stop sign before proceeding through an intersection R_{BASE}(t)=1, while when a driver passing through the same intersection without stopping, R_{BASE}(t)=0. There are however exceptions or cases in which the driver needs to violate the basic traffic rule without having any input or choice. As an example, the vehicle may need to cross a center line of a highway or a two-way street in order to avoid a construction area. The rule exception compliance factor R_{EXCEPT}(t) is used to evaluate performance in these exceptional situations. The value of R_{EXCEPT}(t) can be anywhere between 0 and 1.

The weight factor a in Eq. (2) s a number between 0 and 1. For a simple road scenario, such as a one lane road, α=0. As the road grows in complexity, the value of a increases. Thus, the ability of the driver to obey traffic rules and regulations during a simple road scenario carries more weight in grading the instantaneous performance of the vehicle. For more complex driving, the ability to comply with necessary exception carries more weight in grading the instantaneous performance.

The other component for determining the performance grade of the vehicle in Eq. (1) is the traffic flow compliance, shown in detail below in Eq. (3).

F(t)=G_{MAX}−δD_{speed}(t)−ρD_{speed}(t)−σ(T_{MAX}−T_{FRONT}(t)) Eq. (3)

where G_{MAX} is a maximum possible performance grade, D_{speed}(t), D_{Head}(t) and (T_{MAX}−T_{front}(t)) are penalty components and the variables δ, ρ and σ are weights for each of the penalty components. The speed deviation D_{speed}(t) is the deviation in speed between the autonomous vehicle 10 and other agents 50 (i.e., vehicles, pedestrians, etc.) in the environment. If the speed deviation increases above or below a selected threshold (i.e., the autonomous vehicle is too fast or too slow with respect to the current traffic flow), then the penalty increases. The heading deviation, D_{Head}(t) is the deviation in heading or orientation between the autonomous vehicle 10 and other agents 50. If the heading deviation increases, the autonomous vehicle 10 may run into other agents 50 or can be struck by an agent 50. Thus, as the heading deviations increases, the associated penalty also increases, T_{front}(t) is an expected time interval for the autonomous vehicle 10 to collide with an agent 50 and T_{MAX} is a maximum time interval for the autonomous vehicle to look in advance. The time to collide T_{front}(t) is a time interval that the autonomous vehicle 10 has before colliding with an agent. This factor can be calculated from at least three different components, such as the autonomous vehicle's velocity, the agent's velocity and the distance between the autonomous vehicle and agent.

Combining Eqs. (1)-(3), the instantaneous performance can be written as a product of the traffic rule compliance factor and the traffic flow compliance factor, as shown in Eq. (4):

G_{INST}=(αR_{BASE}(t)+(1−α)R_{EXCEPT}(t))(G_{MAX}−D_{speed}(t)−D_{speed}(t)−T_{FRONT}(t)) Eq. (4)

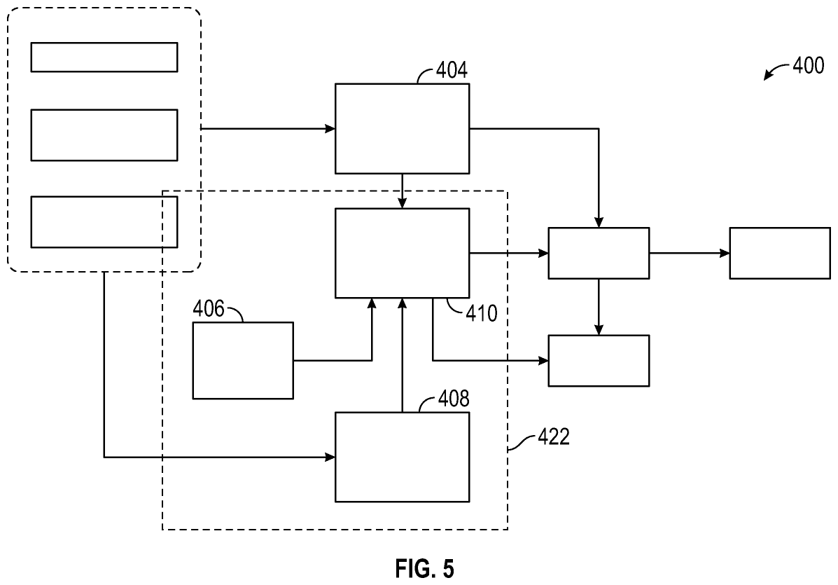

FIG. 5 shows the diagrammed process 400 of FIG. 4 emphasizing a sub-process 422 for determining a temporal performance grade for the plurality of solutions. The sub-process 422 for determining the temporal performance grade includes selecting a plurality of spatial performance grades over a selected time frame. The temporal performance grade, G_{TEMP}(t), contains information from a time frame d_{INTV} that includes three different time frames: past, present and future. The past provides previous performance grades, which are previously calculated and stored in the stored grade history (box 406). The present includes a spatial score such as detailed above with respect to instantaneous performance grading. This spatial score is provided by the instantaneous performance grading module (box 404). The future time includes a predicted performance grade that is provided by predicted performance grade module (box 408). A temporal performance grade module 410 estimates the temporal performance grade, G^{k}_{TEMP}(t) for each possible vehicle decision candidate k, using input from the stored grade history 406, instantaneous performance grade module 404 and predicted performance grade module 408.

The selected time frame d_{INTV} extends from a selected past time through to a selected future time period. The selected past time depends on the occurrence of an event start time. A new event starts when one of the following triggers occurs: (1) a change in a road type (traffic regions) or a change in traffic signal, (e.g. entering an intersection, exiting an intersection, passing a crosswalk, etc.) and (2) non-negligible relative pose changes of neighborhood entities (vehicles, pedestrians, etc.) such as lane changes, speed up, slow down, etc.

In many situations a new event occurs frequently and therefore is common for marking a possible start time for d_{INTV}. However, in some relatively simple situations, such as highway driving, such triggers may not occur frequently, therefore causing a very long d_{INTV} that can be computationally expensive. Therefore, a sliding window of a selected time can be used to mark the beginning of d_{INTV}. The sliding window is marked to the present time. Once an event is too far in the past (i.e., is further in the past as the selected time duration of the sliding window), the start time of d_{INTV} is marked as the earliest time of the sliding window. Using the sliding time window maintains a reasonable past time interval for assessing temporal driving performance. Thus, the time interval d_{INTV} of the entire temporal grade estimating process is given by Eq. (5):

d_{INTV}=[max(e_{START},t−d_{CONST}),t+d_{PREDICT}] Eq. (5)

where e_{START} is the event start time, d_{CONST} is a time duration of a sliding time window, t is the current time, and d_{PREDICT} is a time interval extending into the future over which a prediction can be made.

A plurality of grades are provided within this interval, forming a grade sequence, G_{SEQ}. Within time interval, d_{INTV}, the mean value m_{SEQ}, the standard deviation s_{SEQ}, and the minimum value m_{SEQ}, of the grade sequence G_{SEQ} can be calculated. The maximum value can also be calculated but is generally not used for vehicle control decisions. In general, the mean value m_{SEQ} is important in determining the temporal performance grade. However, a low minimum grade score (i.e., low m_{SEQ}) can indicate risky situations that can lead to accidents. Therefore, the temporal performance grade, G^{k}_{TEMP}(t) is estimated by the combination of the mean value and the minimum value., with equal weight. Thus mean The G^{k}_{TEMP}(t) is calculated as shown in Eq. (6):

G^{k}_{TEMP}(t)=0.5(m_{SEQ}^{k}(t)+min_{SEQ}^{k}(t)) Eq. (6)

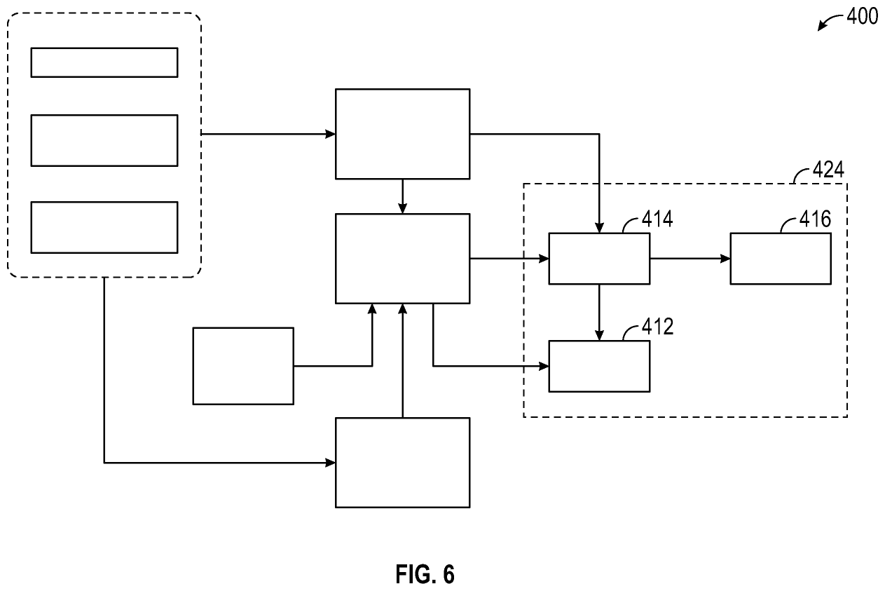

FIG. 6 shows the diagrammed process 400 of FIG. 4 emphasizing a sub-process 424 for determining a final performance grade for the plurality of solutions and selecting an optimal decision. The sub-process 424 includes an integration process 414 in which the instantaneous grade and the temporal grade are combined into a final performance grade 416, employing a weight decision 412. A discussion of the integration process is below.

For each solution k, the instantaneous performance grade and the temporal performance grade can be integrated into a single value that defines a final performance grade at time t. The standard deviation of the temporal grade s_{SEQ} can be used to balance the contribution of each of the instantaneous performance grade and the temporal performance grade towards the final performance grade, as shown in Eq. (7):

$${G}^{k} ( t ) = ( \frac{{S}_{S E Q}}{{S}_{M A X}} ) {G}_{INST} ( t ) + ( 1 - \frac{{S}_{S E Q}}{{S}_{M A X}} ) {G}_{T E M P}^{k} ( t ) \qquad Eq . ( 7 )$$

If a particular sequence of driving displays a high standard deviation (s_{SEQ}), such as in complicated traffic situations, the spatial grade is more important than the temporal grade in determining the final performance grade. On the other hand, in very stable traffic situations, such as in highway driving, the temporal grade is more important than the spatial grade in determining the final performance grade.

Once a final performance grade has been determined in Eq. (7) for each of k decisions, the final performance grades are provided to the decision module. The decision having the maximum final performance grade is selected, as shown in Eq. (8)

$$Decision = arg {max}_{k} {G}^{k} ( t ) \qquad Eq . ( 8 )$$

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of operating an autonomous vehicle, comprising;
receiving a plurality of decisions for operating the autonomous vehicle at a decision resolver of a cognitive processor associated with the autonomous vehicle;
determining a performance grade for each of the plurality of decisions;
selecting a decision have a greatest performance grade; and
operating the autonomous vehicle using the selected decision.

2. The method of claim 1, wherein the performance grade is a combination of an instantaneous performance grade and a temporal performance grade.

3. The method of claim 2, wherein the instantaneous performance grade is based on a compliance with a traffic rule and a compliance with a flow of traffic.

4. The method of claim 2, wherein the temporal performance grade is determined over a time period extending from a start time in the past to an end time in the future.

5. The method of claim 4, wherein the start time is the most recent of (i) a start time of a new event; and (ii) a time indicated by a selected time interval prior to a current time.

6. The method of claim 2, further comprising using a standard deviation of grades in the temporal performance grade to weight the contribution of each of the instantaneous performance grade and the temporal performance grade in the performance grade.

7. The method of claim 2, wherein the temporal performance grade is a combination of a mean grade over a time interval and a minimum grade over the time interval.

8. A system for operating an autonomous vehicle, comprising:
a performance evaluator configured to determine a performance grade for each of a plurality of decisions for operating the autonomous vehicle;
a decision module configured to select a decision having a greatest performance grade; and
a navigation system configured to operate the autonomous vehicle using the selected decision.

9. The system of claim 8, wherein the performance evaluator determines the performance grade as a combination of an instantaneous performance grade and a temporal performance grade.

10. The system of claim 9, further comprising a compliance module that determines a compliance of the vehicle with a traffic rule and a compliance with a flow of traffic, wherein the instantaneous performance grade is based on a compliance with a traffic rule and a compliance with a flow of traffic.

11. The system of claim 9, wherein the performance evaluator determines the temporal performance grade over a time period extending from a start time in the past to an end time in the future.

12. The system of claim 11, wherein the start time is the most recent of (i) a start time of a new event; and (ii) a time indicated by a selected time interval prior to a current time.

13. The system of claim 9, wherein the performance evaluator uses a standard deviation of grades in the temporal performance grade to weight the contribution of each of the instantaneous performance grade and the temporal performance grade in the performance grade.

14. The system of claim 9, wherein the temporal performance grade is a combination of a mean grade over a time interval and a minimum grade over the time interval.

15. An autonomous vehicle, comprising:
a performance evaluator configured to determine a performance grade for each of a plurality of decisions for operating the autonomous vehicle;
a decision module configured to select a decision have a greatest performance grade; and
a navigation system configured to operate the autonomous vehicle using the selected decision.

16. The autonomous vehicle of claim 15, wherein the performance evaluator determines the performance grade as a combination of an instantaneous performance grade and a temporal performance grade.

17. The autonomous vehicle of claim 16, further comprising a compliance module that determines a compliance of the vehicle with a traffic rule and a compliance with a flow of traffic, wherein the instantaneous performance grade is based on a compliance with a traffic rule and a compliance with a flow of traffic.

18. The autonomous vehicle of claim 16, wherein the performance evaluator determines the temporal performance grade over a time period extending from a start time in the past to an end time in the future.

19. The autonomous vehicle of claim 16, wherein the performance evaluator uses a standard deviation of grades in the temporal performance grade to weight the contribution of each of the instantaneous performance grade and the temporal performance grade in the performance grade.

20. The autonomous vehicle of claim 16, wherein the temporal performance grade is a combination of a mean grade over a time interval and a minimum grade over the time interval.
